(19) United States
(12) Patent Application Publication
(10) Pub. No.: US 2019/0032374 A1
(43) Pub. Date: Jan. 31, 2019

(54) HANDLE FOR VEHICLE DOOR AND METHOD OF USING THE SAME

(71) Applicant: Ford Global Technologies, LLC, Dearborn, MI (US)

(72) Inventors: Howard Paul Tsvi Linden, Southfield, MI (US); Onoyom Essien Ekanem, White Lake, MI (US); Jonathan Weiler, Detroit, MI (US); Asaa Harajli, Dearborn, MI (US); Rajesh K. Patel, Farmington Hills, MI (US)

(21) Appl. No.: 15/664,524

(22) Filed: Jul. 31, 2017

(51) Int. Cl. E05B 81/76; H04N 5/235; H04N 5/225; F21S 4/28; E05B 83/16; E05B 17/10; E05B 85/10; B60R 1/00; B60Q 1/22

(52) U.S. Cl. CPC E05B 81/76; H04N 5/2351; H04N 5/2354; H04N 5/2256; F21S 4/28; F21W 2101/02; E05B 17/10; E05B 85/10; B60R 1/00; B60Q 1/22; E05B 83/16

(57) ABSTRACT

A handle for a door of a motor vehicle according to an exemplary aspect of the present disclosure includes, among other things, at least one button configured to lock or unlock the door, a camera, and a printed circuit board including a processor electrically coupled to the at least one button and the camera. A method of use is also disclosed.

### TECHNICAL FIELD

This disclosure relates to a handle for a door of a motor vehicle and a method of using the same.

### BACKGROUND

Vehicle doors are usually opened and closed by way of a handle mounted to the exterior of the vehicle door. Vehicle doors are known to incorporate several electronic components, such as cameras, passive entry systems, and electronic lock/unlock buttons. Trucks, such as pickup trucks, are known to include tailgates, which are doors that typically pivot about their bottom edge to permit access to a bed of the truck. The tailgate of a truck may include various electronic components, each of which are individually packaged and separately mounted within the tailgate.

### SUMMARY

A handle for a door of a motor vehicle according to an exemplary aspect of the present disclosure includes, among other things, at least one button configured to lock or unlock the door, a camera, and a printed circuit board including a processor electrically coupled to the at least one button and the camera.

In a further non-limiting embodiment of the foregoing handle, the handle includes a light source electrically coupled to the processor.

In a further non-limiting embodiment of any of the foregoing handles, the camera is a backup camera, and the light source is configured to emit light to illuminate a field of view of the camera.

In a further non-limiting embodiment of any of the foregoing handles, the processor is configured to interpret a signal from the camera to detect a level of ambient light, and the processor is configured to adjust an intensity of light emitted by the light source in response to the detected level of ambient light.

In a further non-limiting embodiment of any of the foregoing handles, the light source includes at least one light emitting diode.

In a further non-limiting embodiment of any of the foregoing handles, the light source includes a strip of light emitting diodes extending along a length of the handle.

In a further non-limiting embodiment of any of the foregoing handles, the light source includes a plurality of light emitting diodes arranged around a perimeter of the camera.

In a further non-limiting embodiment of any of the foregoing handles, the at least one button is mounted on a first side of the printed circuit board, and the camera is mounted on a second side of the printed circuit board opposite the first side.

In a further non-limiting embodiment of any of the foregoing handles, the handle further includes an antenna electrically coupled to the processor. The antenna is configured to detect a key of the motor vehicle. The processor is configured to permit access to the vehicle when the key is within range of the antenna.

In a further non-limiting embodiment of any of the foregoing handles, the handle further includes a lock status light electrically coupled to the processor. The lock status light configured to indicate whether the door is locked or unlocked.

In a further non-limiting embodiment of any of the foregoing handles, the lock status light illuminates a first color when the door is locked and a second color different than the first color when the door is unlocked.

In a further non-limiting embodiment of any of the foregoing handles, the at least one button includes a first button configured to unlock the door and a second button configured to lock the door.

In a further non-limiting embodiment of any of the foregoing handles, the first button and the second button each include at least one tactile switch.

In a further non-limiting embodiment of any of the foregoing handles, the door is a tailgate and the motor vehicle is a truck.

A motor vehicle according to an exemplary aspect of the present disclosure includes, among other things, a door selectively opened by a handle. The handle includes at least one button configured to lock or unlock the door, a camera, and a printed circuit board including a processor electrically coupled to the at least one button and the camera.

In a further non-limiting embodiment of the foregoing motor vehicle, a light source is electrically coupled to the processor.

In a further non-limiting embodiment of any of the foregoing motor vehicles, the camera is a backup camera, and the light source is configured to emit light to illuminate a field of view of the camera.

In a further non-limiting embodiment of any of the foregoing motor vehicles, the processor is configured to interpret a signal from the camera to detect a level of ambient light, and the processor is configured to adjust an intensity of light emitted by the light source in response to the detected level of ambient light.

A method according to an exemplary aspect of the present disclosure includes, among other things, illuminating a field of view of a backup camera by emitting light from a light source. The light source and the backup camera are electrically coupled to a printed circuit board within a handle of a vehicle door. The method further includes detecting a level of ambient light based on a signal from the backup camera, and adjusting an intensity of the light emitted from the light source based on the detected level of ambient light.

In a further non-limiting embodiment of the foregoing method, the adjusting step includes increasing the intensity of the light emitted from the light source when the detected level of ambient light decreases, and the adjusting step also includes decreasing the intensity of the light emitted from the light source when the detected level of ambient light increases.

### BRIEF DESCRIPTION OF THE DRAWINGS

FIG. 1 is a rear view of a motor vehicle with an example handle.

FIG. 2 is a close-up view of the handle of FIG. 1.

FIG. 3 schematically illustrates a first arrangement of a handle.

FIG. 4 schematically illustrates a second arrangement of a handle.

### DETAILED DESCRIPTION

This disclosure relates to a handle for a door of a motor vehicle. In one example, the motor vehicle is a truck, such as a pickup truck, and the door is a tailgate. The handle includes at least one button configured to lock or unlock the door. The handle also includes a camera, which may be a backup camera, and a printed circuit board. The printed circuit board includes a processor electrically coupled to the button(s) and the camera. Providing a common printed circuit board for these and, optionally, other electronic components within the handle of the vehicle reduces clutter and eliminates the need for separate wiring harnesses, which in turn reduces vehicle weight, reduces vehicle cost, and improves fuel efficiency. Further, the handle serves as a heat sink for the camera, which reduces the need to provide a separate, dedicated heat sink adjacent the camera.

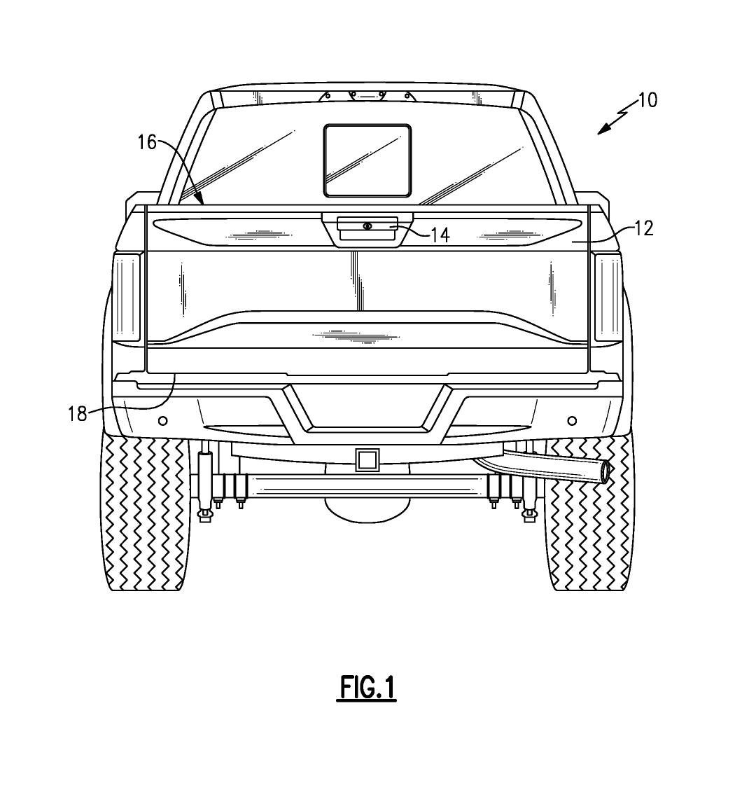

Referring to the drawings, FIG. 1 is a rear view of a motor vehicle 10. As shown, the vehicle 10 is a truck, such as a pickup truck. While a truck is pictured, this disclosure is also applicable to sport utility vehicles (SUVs) and other types of vehicles. The vehicle 10 includes a door, which in this example is a tailgate 12, having a handle 14. The handle 14 can be actuated by a user to selectively open the tailgate 12, providing the user with access to a bed 16 of the vehicle 10 from the rear. The tailgate 12 is hinged adjacent its bottom edge 18, in this example. While a tailgate 12 is shown in this disclosure, it should be understood that this disclosure is not limited to trucks and is not limited to tailgates. For example, this disclosure could apply to sport utility vehicles (SUVs), which include liftgates configured to open to expose a vehicle interior.

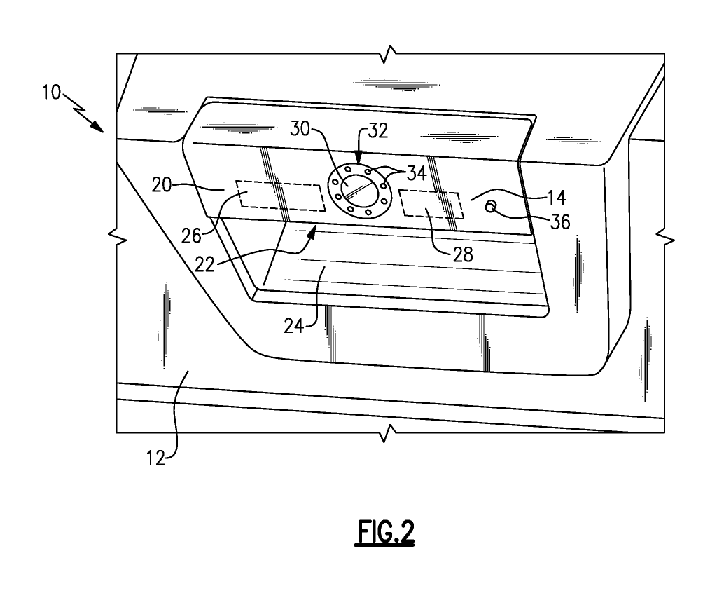

With reference to FIG. 2, the handle 14 includes an exterior surface 20 and an interior surface 22 accessed by a user via a recess 24 in the tailgate 12 below the handle 14. In order to open the liftgate 12, the user places their fingers on the interior surface 22 and applies a force to the interior surface to rotate the handle 14. In some examples, the handle 14 is electronically actuated and is not rotatable.

The tailgate 12 of the vehicle 10 may include a number of electronic components. In particular, in this example, the handle 14 includes a plurality of electronic components. For example, the interior surface 22 of the handle 14 includes at least one button which, when depressed, is configured to lock or unlock the tailgate 12. The button may include one or more tactile switches. In one example, the interior surface 22 includes a first button 26 configured to unlock the tailgate 12 and a second button 28 configured to lock the tailgate 12. The first and second buttons 26, 28 are shown in phantom in FIG. 2. While two buttons are shown, the handle 14 could include a single button configured to both lock and unlock the tailgate 12.

Further, in this example, the exterior surface 20 of the handle 14 includes a camera 30 and a light source 32. The camera 30 is a backup camera and is mounted to the handle 14 such that a field of view of the camera 30 can assist the driver of the vehicle 10 when driving in reverse. The light source 32 is configured to emit and project light to illuminate the field of view of the camera 30, which increases visibility at night or in low light conditions. Mounting the camera 30 in the handle 14 has the advantage of eliminating the need for a separate, dedicated camera heat sink. Rather, the handle 14 itself serves as a heat sink for the camera 30. Eliminating the heat sink reduces cost and reduces vehicle weight.

The light source 32 in this example is provided by a plurality of light emitting diodes (LEDs) 34. The LEDs 34, in this example, are arranged such that they surround a perimeter of the camera 30. In particular, the LEDs are equally spaced-apart from one another about a circumference of the camera 30. In this example, there are eight LEDs, but it should be understood that this disclosure extends to other types of light sources, including light sources having a different LED arrangement, and including light sources that do not include LEDs.

The exterior surface 20 of the handle 14 may also include a lock status light 36. The lock status light 36 may be provided by an LED, and may be configured to illuminate different colors depending on whether the tailgate 12 is locked or unlocked. In one example, the lock status light 36 emits a green light color when the tailgate 12 is unlocked, and the lock status light 36 emits a red color when the tailgate 12 is locked. Thus, a user can tell whether the tailgate 12 is locked or unlocked based on the color of the lock status light 36. While green and red are mentioned, this disclosure is not limited to any particular colors for the lock status light 36.

The handle 14 may include additional electronic components beyond the buttons 26, 28, camera 30, light source 32, and the lock status light 36. In this disclosure, the electronic components of the handle 14 are mounted to a single, common printed circuit board (PCB) provided within the handle 14. The printed circuit board includes at least one processor (e.g., a microprocessor) electrically coupled to each of the electronic components of the handle 14. Mounting the electronic components to a common printed circuit board eliminates the need for separate component packaging, and in particular eliminates the need for separate, dedicated wire harnesses running to each electronic component. In turn, the disclosed arrangement reduces cost and reduces vehicle weight.

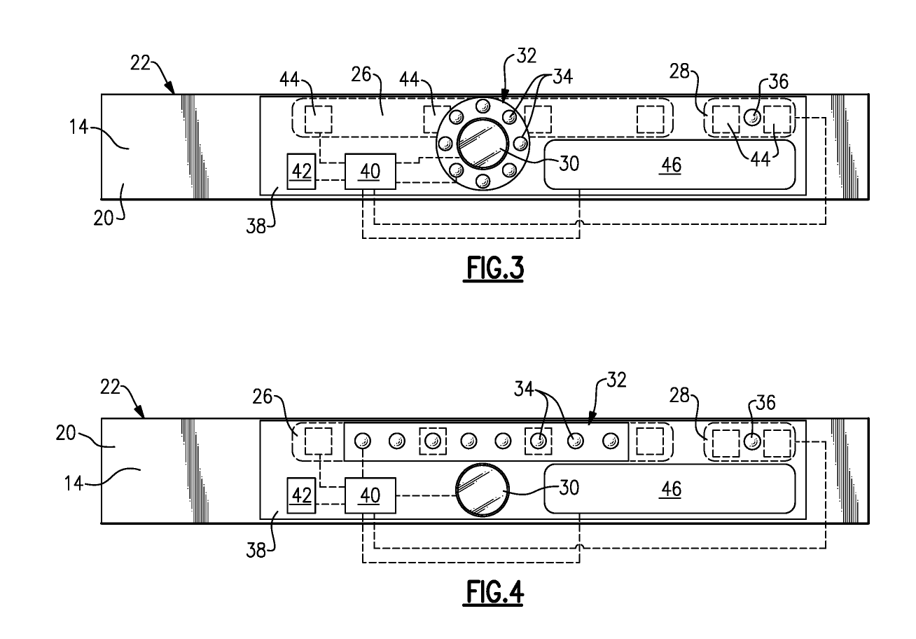

FIG. 3 schematically illustrates a first arrangement of the handle 14. Specifically, FIG. 3 schematically illustrates a printed circuit board 38 mounted within the handle 14 and a number of electronic components mounted to the printed circuit board 38. With reference to FIG. 2, the printed circuit board 38 is mounted within the handle 14, somewhere between the exterior surface 20 and the interior surface 22.

The printed circuit board 38 may be a known type of printed circuit board including strips of conducting material such as copper, which have been etched and are fixed to a flat insulating sheet. The printed circuit board 38 includes, among other things, a processor 40, which may be a microprocessor. The processor 40 is electrically coupled to each of the electronic components mounted to the printed circuit board 38. The processor 40 may be a known type of processor, such as a microprocessor, programmed with executable instructions for interfacing with and operating the various electronic components mounted to the printed circuit board 38. The processor 40 may additionally include non-transitory memory for executing the various control strategies. Further, while one processor is shown, it should be understood that the printed circuit board 38 could include multiple processors.

The printed circuit board 38 further includes a module connector 42, in this example, which electrically couples the printed circuit board 38, and the various electronic components mounted thereto, to the remainder of the vehicle 10. Specifically, the module connector 42 is configured to communicate with a main controller of the vehicle 10, such as a vehicle system controller (VSC).

FIG. 3 schematically shows a plurality of electronic components mounted to the printed circuit board 38. For example, the first and second buttons 26, 28, each of which includes one or more tactile switches 44, are mounted to the printed circuit board 38 on a side facing the interior surface 22 of the handle 14. Thus, the first and second buttons 26, 28 can be activated by a user as described above. The first and second buttons 26, 28 are shown in phantom in FIG. 3 to represent that they are mounted on a side of the printed circuit board 38 facing the interior surface 22.

The camera 30, light source 32, and lock status light 36 are mounted to the printed circuit board 38 on a side facing the exterior surface 20 of the handle 14 so that these components can achieve the above-described functionality. Further, in this disclosure, an antenna 46, such as a passive-entry-passive-start (PEPS) antenna, is also mounted to the printed circuit board 38. The antenna 46 is configured to detect the presence of a key (e.g., a key fob) of the vehicle 10. When the key is within range of the antenna 46, the antenna 46 sends a signal to the processor 40 indicating that access to the vehicle 10 can be permitted. In one example, the signal indicates that the tailgate 12 can be unlocked.

In the example of FIG. 3, the processor 40 is electrically coupled to each of the electronic components of the handle 14. In particular, in this example, the processor 40 is electrically coupled to the first and second buttons 26, 28, the camera 30, the light source 32, the lock status light 36, and the antenna 46. The processor 40, either independently or in response to instructions from another controller within the vehicle 10, is configured to operate each of these electronic components. That is, the processor 40 is configured to send instructions to, and receive information from, each of these electronic components. In turn, the electronic components are responsive to instructions from the processor 40, and the processor 40 is configured to interface with various other electronic components of the vehicle, either directly or via the module connector 42. For example, to perform an unlocking function, the processor 40 is configured to interpret a signal from the antenna 46 indicating that a known key is within range of the antenna 46, coupled with a signal indicating a user has depressed the button 26, and to then send a request to an actuator associated with a lock of the tailgate 12 to unlock the tailgate 12.

The processor 40 is also configured to control the camera 30 and the light source 32. In one example, the camera 30 is used to detect a level of ambient light adjacent the vehicle 10. That is, the camera 30 is configured to generate signals corresponding to the images captured by the camera 30, and the processor 40 is configured to determine a level of ambient light adjacent the vehicle 10 based on those signals. In this way, the camera 30 serves as an ambient light sensor. Thus, there is no need to provide a dedicated ambient light sensor.

When the vehicle 10 is being driven at night or in low light conditions, such as when fog is present, the processor 40 is configured to identify that the level of ambient light adjacent the vehicle 10 is low. The processor 40 is also configured to distinguish between various low light conditions, and is further configured to distinguish between conditions where the vehicle is being driven at night versus during a foggy condition, as examples.

In response to the detected level of ambient light, the processor 40 is configured to adjust the intensity of the light emitted by the light source 32. In this disclosure, intensity refers to luminous intensity, which is perceived as increased brightness and provides additional visibility in low light conditions. The processor 40 is configured to increase the intensity of the light emitted from the light source 32 when the detected level of ambient light decreases. Likewise, the processor 40 is also configured to decrease the intensity of the light emitted from the light source 32 when the detected level of ambient light increases. When driving at night, for example, the light emitted from the light source 32 may be set to a relatively high intensity, whereas little or no light is required of the light source 32 during daytime driving, which conserves energy.

FIG. 4 schematically illustrates a second arrangement of the handle 14. FIG. 4 is substantially the same as FIG. 3, except that the light source 32 is provided by a relatively thin strip of LEDs 34 extending along a length of the handle 14 (i.e., parallel to a width of the vehicle 10). The light source arrangement of FIG. 4 may be capable of being packaged into handles sized differently than the handle shown in FIG. 2. Further, while two example light source arrangements are shown in FIGS. 3 and 4, it should be understood that additional light source arrangements come within the scope of this disclosure.

It should be understood that terms such as “about,” “substantially,” and “generally” are not intended to be boundaryless terms, and should be interpreted consistent with the way one skilled in the art would interpret those terms. Further, directional terms such as “top” and “bottom” are used for purposes of explanation only and should not otherwise be construed as limiting.

Although the different examples have the specific components shown in the illustrations, embodiments of this disclosure are not limited to those particular combinations. It is possible to use some of the components or features from one of the examples in combination with features or components from another one of the examples.

One of ordinary skill in this art would understand that the above-described embodiments are exemplary and non-limiting. That is, modifications of this disclosure would come within the scope of the claims. Accordingly, the following claims should be studied to determine their true scope and content.

1. A handle for a door of a motor vehicle, comprising:
at least one button configured to lock or unlock the door;
a camera; and
a printed circuit board including a processor electrically coupled to the at least one button and the camera.

2. The handle as recited in claim 1, further comprising:
a light source electrically coupled to the processor.

3. The handle as recited in claim 2, wherein the camera is a backup camera, and wherein the light source is configured to emit light to illuminate a field of view of the camera.

4. The handle as recited in claim 3, wherein the processor is configured to interpret a signal from the camera to detect a level of ambient light, and the processor is configured to adjust an intensity of light emitted by the light source in response to the detected level of ambient light.

5. The handle as recited in claim 2, wherein the light source includes at least one light emitting diode.

6. The handle as recited in claim 5, wherein the light source includes a strip of light emitting diodes extending along a length of the handle.

7. The handle as recited in claim 5, wherein the light source includes a plurality of light emitting diodes arranged around a perimeter of the camera.

8. The handle as recited in claim 1, wherein the at least one button is mounted on a first side of the printed circuit board, and wherein the camera is mounted on a second side of the printed circuit board opposite the first side.

9. The handle as recited in claim 1, further comprising:
an antenna electrically coupled to the processor, the antenna configured to detect a key of the motor vehicle, and wherein the processor is configured to permit access to the vehicle when the key is within range of the antenna.

10. The handle as recited in claim 1, further comprising:
a lock status light electrically coupled to the processor, the lock status light configured to indicate whether the door is locked or unlocked.

11. The handle as recited in claim 10, wherein the lock status light illuminates a first color when the door is locked and a second color different than the first color when the door is unlocked.

12. The handle as recited in claim 1, wherein the at least one button includes a first button configured to unlock the door and a second button configured to lock the door.

13. The handle as recited in claim 12, wherein the first button and the second button each include at least one tactile switch.

14. The handle as recited in claim 1, wherein the door is a tailgate and the motor vehicle is a truck.

15. A motor vehicle, comprising:
a door selectively opened by a handle, the handle comprising at least one button configured to lock or unlock the door, a camera, and a printed circuit board including a processor electrically coupled to the at least one button and the camera.

16. The motor vehicle as recited in claim 15, further comprising:
a light source electrically coupled to the processor.

17. The motor vehicle as recited in claim 16, wherein the camera is a backup camera, and wherein the light source is configured to emit light to illuminate a field of view of the camera.

18. The motor vehicle as recited in claim 17, wherein the processor is configured to interpret a signal from the camera to detect a level of ambient light, and the processor is configured to adjust an intensity of light emitted by the light source in response to the detected level of ambient light.

19. A method, comprising:
illuminating a field of view of a backup camera by emitting light from a light source, the light source and the backup camera electrically coupled to a printed circuit board within a handle of a vehicle door;
detecting a level of ambient light based on a signal from the backup camera; and
adjusting an intensity of the light emitted from the light source based on the detected level of ambient light.

20. The method as recited in claim 19, wherein the adjusting step includes increasing the intensity of the light emitted from the light source when the detected level of ambient light decreases, and wherein the adjusting step includes decreasing the intensity of the light emitted from the light source when the detected level of ambient light increases.
